(19) United States
(12) Patent Application Publication
(10) Pub. No.: US 2015/0151869 A1
(43) Pub. Date: Jun. 4, 2015

(54) Blow Moulded Bottle, Method of Manufacturing and Mould

(71) Applicants: SOCIETE ANONYME DES EAUX MINERALES D'EVIAN, Evian-les-Bains (FR); ENVASADORAS DEAGUAS EN MEXICO, S. DE R.L. DE C.V., Mexico City (MX)

(72) Inventors: Jorge Alejandro Gil Dominguez, Tulancingo De Bravo (MX); Isabelle Fandeux, Evian-les-Bains (FR); Vincent Loisel, Thollon Les Memises (FR)

(73) Assignees: SOCIETE ANONYME DES EAUX MINERALES D'EVIAN, Evian-les-Bains (FR); ENVASADORAS DEAGUAS EN MEXICO, S. DE R.L. DE C.V., Mexico City (MX)

(21) Appl. No.: 14/405,681

(22) PCT Filed: Jun. 4, 2013
(86) PCT No.: PCT/EP2013/061434

§ 371 Date: Dec. 4, 2014

(30) Foreign Application Priority Data
Jun. 5, 2012 (MX) MX/A/2012/006459

(51) Int. Cl. B65D 1/02; B29C 49/48; B29C 49/62; B29D 22/00

(52) U.S. Cl. CPC B65D 1/02; B29D 22/003; B29C 49/48; B29C 49/62; B29L 2031/7158

(57) ABSTRACT

A blow moulded plastic bottle includes a neck, a shoulder, a tubular body portion, and an integral bottom structure including: a terminal curved portion, an internal axially inwardly directed dome, and an (annular) base joining the terminal curved portion to the dome; wherein: a spline comprises a flat part in the base plane (Pb) onto the bottle rests when it stands up; the height (h1) between (Pb) and the apex of the dome, the height (h2) between (Pb) and the spline diametral median plane (Pd) which is in the middle of the spline (17) and which is parallel to (Pb), and the maximum external diameter (Dm) of the tubular body portion, being so that [(h1)/(Dm)]*100 is comprised between 14.0 and 16.0% and (h1)<(h2)≦3.5(h1).

### FIELD OF THE INVENTION

This invention relates generally to the construction of a bottle suitable for containing water or other liquids. It is particularly applicable to the construction of bottles for containing water for human consumption (generically drinking water hereafter) and which are used in conjunction with water dispensing units and carrying crates or racks.

### BACKGROUND OF THE INVENTION

Bottles, also named jugs, which are employed in the servicing of drinking, water dispensing units are customarily cylindrical in form. Such bottles, when applied to units of the electrical or non-electrical type, are inverted and positioned upon the upper portion of the dispensing unit to supply water to an inner reservoir as it is being dispensed. Water is supplied to the reservoir from a replaceable bottle which is inverted on the top of the cooler unit, the neck of the bottle being placed in a funnel-shaped inlet to the reservoir at the top of the dispensing unit. Pumps can also be used to supply water out of the jugs. The capacity of a typical bottle is of the order of five gallons. When all the water in the bottle has been dispensed the empty bottle is removed and replaced by another full bottle. Usually a supply of full bottles is kept at the site and from time to time the supplier will deliver a fresh supply of filled bottles and collect the empty bottles for cleaning and refilling.

The known bottles have a body which is circular in cross section and a neck which is joined to the cylindrical body of the bottle by a sloping upper end portion. These bottles usually have a 5 gallons capacity bottles, possibly present a handle, and are designed with a screw or a snap neck. The bottles are blow moulded from plastic material such as polyester terephtalate or polycarbonate. A plastic cap fits over the top of the neck to close the bottle whilst it is in transit or storage. When the bottle is inverted on the top of the dispensing unit, the sloping upper end portion of the bottle rests in a concave recess in the top of the dispensing unit around the funnel-shaped inlet.

During transportation to and from dispensing units being serviced, the bottles are usually disposed within individual carrying crates, racks or pallets which accommodate a plurality of bottles. They are difficult to lift and manoeuvre into position on the cooler unit because of their bulk and weight when full.

Because these jugs are returnable and refillable, they are thus subjected to numerous handling and storage operations and conditions, wherein they are exposed to mechanical constraints such as abrasive wear, notably in the contact area between the jugs after stacking, or such as drops.

Then, the requirements of the moulded plastic jugs are notably:
i) Resistance to abrasion (scuffing) and
ii) Impact or drop resistance.

In this respect, the moulded plastic jugs have a wall thickness of at least 400 μm, preferably 500 μm, and more preferably comprised between 600 and 1500 μm. This wall thickness requirement is linked to the relatively large capacity of the bottle, i.e at least, in an increasing order of preference and in liters: 10; 15; 21.

Up to now, most of the moulded plastic jugs are obtained by blow molding of polycarbonate which appears to be the most appropriate blow mouldable plastic raw material notably with regard to the requirements (i) & (ii). But the polycarbonate is a heavy and expensive raw material and also as polycarbonate is made from bisphenol A and as bisphenol A is an endocrine disruptor, polycarbonate could be forbidden for making beverage containing jugs.

The polyesters such as Polyethylene Terephtalate (PET) is suitable as far as the weight and the cost are concerned but they do not make it possible to manufacture by molding (especially blow molding) bottles resistant to scuffing and to shocks.

U.S. Pat. No. 4,334,627 discloses a blow moulded plastic bottle for beverages, said bottle being of the type including a tubular body portion and an integral bottom structure. Said bottom structure, includes a truncated hemispherical upper portion, an internal conical portion, and a junction ring joining the two. In addition, the bottom structure, particularly the conical portion and the junction ring, is reinforced by circumferentially spaced radiating ribs formed on the inner surface of the bottom structure. The ribs extend generally from the outer periphery of the top apex of the conical portion and across the junction ring, terminating in the outer wall.

U.S. Pat. No. 5,599,496 describes a method of blow molding a preform into a returnable and refillable container having a biaxially oriented body and low orientation base, the container including the neck finish, a shoulder formed from the shoulder-forming portion of the preform, a body formed from the body-forming portion of the preform, and a base formed from the base-forming portion of the preform, the base including a central downwardly-opening dome segment, a chime, and an outer base portion gradually increasing in diameter upwardly to the body;

These prior references propose technical solutions which could be adapted to give a good resistance to pressure but which are not satisfactory notably with regards to the above mentioned requirements: (i) Resistance to abrasion (scuffing) and (ii) Impact or drop resistance.

### OBJECTIVES OF THE INVENTION

In the above recalled background, the invention aims at fulfilling at least one of the following objectives:
1. Providing (blow) mold plastic bottles which can be used in servicing of beverages (e.g. water) units, which have relatively high volumetric capacity, which can be used in conjunction with carrying crates, racks or pallets or which can also be transported loose in trucks; and which have high resistance to scuffing and high resistance to shock (drop).
2. Providing (blow) mold plastic bottles which are refillable and reusable, and so environment-friendly, cost effective and which have high resistance to scuffing and high resistance to shock (drop).
3. Providing (blow) mold plastic bottles which fulfil the objectives 1 and/or 2 and which are safe and light in order to compete with refillable and reusable polycarbonate or other polymer containers.
4. Providing (blow) mold plastic bottles which could have high volumetric capacity (e.g. between 10 liters up to 21 liters) while having high resistance to scuffing and high resistance to shock (drop) for handling and storage (crate, rack, pallet or loose).
5. Providing (blow) mold plastic bottles which fulfil at least one of the objectives 1 to 4 and which have an attractive appearance during its shelf life.
6. Providing a moulded plastic preform for the manufacture by (blow) molding of bottles as referred to in at least one of the objectives 1 to 5.
7. Providing a cost effective and high-performance method for the manufacture by (blow) molding of bottles as referred to in at least one of the objectives 1 to 5.
8. Providing a mold for the manufacture by (blow) molding of bottles as referred to in at least one of the objectives 1 to 5.

### SUMMARY OF THE INVENTION

The above objectives, among others, are fulfilled by the present invention which concerns, in a first aspect, a (blow) moulded plastic bottle for beverages, said bottle being of the type including from the top to the base:
a neck
a shoulder
a tubular body portion
and an integral bottom structure including:
   a terminal curved portion
   an internal axially inwardly directed dome
   and an (annular) base joining the terminal curved portion to the dome;
      wherein:
i. a continuous or discontinuous spline is designed between the tubular body portion and the terminal curved portion;
ii. the (annular) base comprises a part, preferably a flat part, which is included in the base plane (Pb) onto the bottle rests when it stands up;
iii. the height (h1) between (Pb) and the apex of the dome, the height (h2) between (Pb) and the spline diametral median plane (Pd) which is in the middle of the spline mentioned above in (i) and which is parallel to (Pb),
   and the maximum external diameter (Dm) of the tubular body portion, being so that at least one of the following design features is fulfilled:
   a. [(h1)/(Dm)]*100 is, [in % and in an increasing order of preference]:
      greater than 11, greater than or equal to 11.5; 12.0; 12.5; 13.0; 13.5;
      comprised between 14.0 and 20.0; 14.0 and 18; 14.0 and 16.0;
   b. In an increasing order of preference:
      (h1)<(h2)≦1.5(h1)
      (h1)<(h2)≦2.0(h1)
      (h1)<(h2)≦2.5(h1)
      (h1)<(h2)≦3.0(h1)
      (h1)<(h2)≦3.5(h1).

The present invention also concerns, in this first aspect, a (blow) moulded plastic bottle for beverages, said bottle being of the type including from the top to the base:
a neck
a shoulder
a tubular body portion
and an integral bottom structure including:
   a terminal curved portion
   an internal axially inwardly directed dome
   and an (annular) base joining the terminal curved portion to the dome;
      wherein:
i. a continuous or discontinuous spline is designed between the tubular body portion and the terminal curved portion;
ii. the (annular) base comprises a part, preferably a flat part, which is included in the base plane (Pb) onto the bottle rests when it stands up;
iii. the height (h1) between (Pb) and the apex of the dome, the height (h2) between (Pb) and the spline diametral median plane (Pd) which is in the middle of the spline mentioned above in (i) and which is parallel to (Pb),
   and the maximum external diameter (Dm) of the tubular body portion, being so that at least one of the following design features is fulfilled:
   a. [(h1)/(Dm)]*100 is, [in % and in an increasing order of preference]:
      greater than 11, greater than or equal to 11.5; 12.0; 12.5; 13.0; 13.5;
      comprised between 14.0 and 20.0; 14.0 and 18; 14.0 and 16.0;
   b. In an increasing order of preference:
      (h1)<(h2)≦1.5(h1)
      (h1)<(h2)≦2.0(h1)
      (h1)<(h2)≦2.5(h1)
      (h1)<(h2)≦3.0(h1)
      (h1)<(h2)≦3.5(h1),
said bottle comprising at least one embossed outer area to limit scuffing.

The bottle according to the invention is endowed with the required mechanical/physical properties (shocks & scuffing strength), lightness, and attractive appearance deemed necessary to refillable plastic containers.

The bottle according to the invention offers the best balance of properties and cost/performance ratios.

In a second aspect, the invention pertains to a moulded plastic preform for the manufacture by blow molding of the bottle according to the invention.

In a third aspect, the invention relates to a method for the manufacture by blow molding of the bottle according to the invention. Said method comprises the steps of:
A. moulding a plastic preform according to the invention, said preform being of the type including from the top to the base:
   a neck;
   a shoulder;
   and a closed tubular body portion the external diameter of which is (dt) and/or the height of which is (ht);
B. possibly heat conditioning and preblowing the preform obtained in step A so as to increase:
   (dt) [in % and in an increasing order of preference]: of at least, 5; 10; 15; 20; between 20 and 40;
   and/or (ht) [in % and in an increasing order of preference]: of at least, 0; 0.5; 1.0; 5; 10; between 10 and 20;
C. possibly inserting a handle in the blowing mold;
D. stretch blow moulding of the preform of step A and possibly step B and/or step C, in a mould the cavity of which being the bottle according to the invention; said stretch blow molding comprising the blowing of the softened preform to get a bubble of plastic which comes into contact with the bottom of the cavity of the spline and with the cavity of the dome so as to stretch the plastic all around the bottom of the mold in order to obtain finally the terminal curved portion of the bottle;
E. taking out of the bottles.

In a fourth aspect, the invention relates to a mold for the manufacture by blow molding of the bottle according to the invention. Said mold is characterized in that:
the cavity of said mold is designed according the bottle according to the invention,
said mold comprises venting holes facing the embossed with etching outer area(s) and regularly disposed around the circular cavities of the embossed outer area(s);
said venting holes have a diameter [in mm and in an increasing order of preference]: greater than or equal to 1; 2; 3; 4; comprised between 4 and 6;
the surface of these venting holes corresponding preferably to a percentage of the surface of the embossed area(s) [in an increasing order of preference]: greater than or equal to 0.05; 0.2; 0.3; 0.4; comprised between 0.45 and 0.7.

Said preform, manufacturing method and mold are very well adapted to the industrial constraints of high productivity, high quality, low cost.

### Preferences

According to an advantageous feature .c. of the invention:
the wall thickness (t0) at the origin (0) of at least one of the generatrix of the bottle, said origin being the lower point of the terminal curved portion, said lower point being on the plane (Pb), on the external circle of the (annular) base,
the wall thickness (t+90) at the abscissa (+90) which is the abscissa at the intersection between the spline diametral median plane (Pd) and the generatrix,
and the wall thickness (t−100) at the abscissa (−100) which is the abscissa at the apex of the dome;
being so that:
   the wall thickness (t) between the abscissas (t0) and (t+90) is comprised 0.3*(t0) and 1.00*(t90), preferably between 0.5*(t0) and 0.9(10), and, more preferably between 0.7*(t0) and 0.9*(t0);
   the wall thickness (t) between the abscissas (t0) and (t−100) is comprised 1.0*(t0) and 6.0*(t0), preferably between 1.2*(t0) and 5.0*(t0), and, more preferably between 1.5*(t0) and 4.0*(t0).

The bottle according to the invention is preferably made by injection blow moulding or injection stretch blow moulding, of a (thermo) plastic material chosen preferably among the polymers which exhibit strain hardening when they are elongated, and, more preferably among the polyesters, particularly the aromatic polyesters, more particularly chosen in the group comprising, and even more particularly consisting in: PolyEthylene Terephtalate (PET) and/or PolyEthylene-Naphtalate (PEN) or PolyEthylene Furanoate (PEF).

The neck of the bottle according to the invention is preferably designed in order to receive a screwed cap or a snap cap.

In a preferred embodiment, the bottle according to the invention has an (annular) base which is substantially flat.

According to an outstanding feature, the (moulded) plastic bottle according to the invention, the minimum internal diameter (Di) of the continuous or discontinuous spline is so that [(h1)/(Di)]*100 is, in % and in an increasing order of preference:
greater or equal to 10.0; 11.0; 12.0; 13.0; 13.5;
comprised between 14.0 and 20.0; 15.0 and 18.0; 15.0 and 17.0.

In another favourite embodiment, the bottle according to the invention, the bottom of the spline is substantially flat.

Advantageously, the (moulded) plastic bottle according to the invention, the terminal curved portion of the integral bottom structure is crystalline, according to the below definition.

According to an outstanding feature, the (annular) base joining the terminal curved portion to the dome, has high crystallisation rate, according to the below definition. Therefore, this area exposed to mechanical shocks and constraints has a good mechanical resistance.

According to another outstanding feature, the dome is amorphous because the end of the preform is less stretched, and thus exhibits a low crystallisation rate and lower mechanical resistance, according to the below definition.

In a such integral bottom structure, the terminal curved portion makes it possible to protect the bottle against the shocks, especially with respect to the dome which is usually amorphous, considering the manufacture processes, wherein the dome area is generally not stretched and thus not transformed from the amorphous state to the crystalline state.

The tubular body portion of the (moulded) plastic bottle according to the invention, preferably comprises at least one recess, wherein a handle is preferably fitted.

The at least one embossed outer anti-scuffing area of the (moulded) plastic bottle according to the invention, comprises two embossed outer areas, on both sides of the recess.

These embossed areas are placed around the bottle. They are annular when the bottle presents a circular cross section. They can be discontinuous or continuous. They are designed so as to be in the contact areas of the bottle with other bottles on the line or during transportation on palette or in contact with rack or crates

Concerning the depth of the holes of the embossed outer areas, it is advantageously [in mm and in an increasing order of preference]: greater than or equal to 0.3; 0.4; 0.5; comprised between 0.6 to 0.9.

### DEFINITIONS

According to the terminology of this text, the following non limitative definitions have to be taken into consideration:
Every singular designates a plural and reciprocally.
“bottle” refers to any container for liquids, especially beverages like water: bottles, jugs, fountains, barrels, in particular adapted for beverage dispensers (Home & Office Delivery HOD), the capacity of which being, for instance, between 10 liters and 21 liters.
“plastic” refers to mouldable thermoplastic homopolymer or copolymer which preferably exhibits strain hardening when they are elongated.
“high crystalline rate” means that the plastic has a degree of crystallinity determined by density to greater than or equal to 20%, preferably to 45%.
“low crystalline rate” means that the plastic has a degree of crystallinity determined by density to lower than 20%.
“amorphous” refers to a plastic with a low crystalline rate.
“moulded” refers to any forming technique of thermoplastic raw materials, such as extrusion blow moulding, extrusion profiles & sheet, injection blow moulding, injection moulding injection moulding (gas assisted), injection stretch blow moulding insert moulding, rotational moulding.
“substantially” means in a proportion of at least [in % and in an increasing order of preference]: 90; 92; 94; 96; 98; 99.

### DETAILED DESCRIPTION OF THE INVENTION

The following description of a preferred embodiment and an example of the invention, will make it possible to well understand the invention and to emphasize all its advantages and variants.

### BRIEF DESCRIPTION OF THE DRAWINGS

This description is made in reference to the enclosed drawings wherein:

FIG. 1 is a front view of a bottle (a jug) according to the invention, without a cap.

FIG. 1A is a bottom view of the bottle of FIG. 1.

FIG. 2 is a front view of a bottle (a jug) shown on FIG. 1 closed by a cap.

FIG. 3 is an enlarged view of a part III of an annular embossed outer area of the bottle of FIG. 1.

FIG. 4 is an enlarged fragmentary vertical and axial sectional view taken through the bottle of FIGS. 1, 1A & 2.

FIG. 5 is partially a right side view of a preform for forming the bottle of FIGS. 1, 1A & 2 and partially a right vertical and axial sectional view taken through said preform.

FIG. 6 is a graph showing the wall thickness of the bottle of FIGS. 1&2, along the graduated generatrix shown on the bottle of FIGS. 1&4.

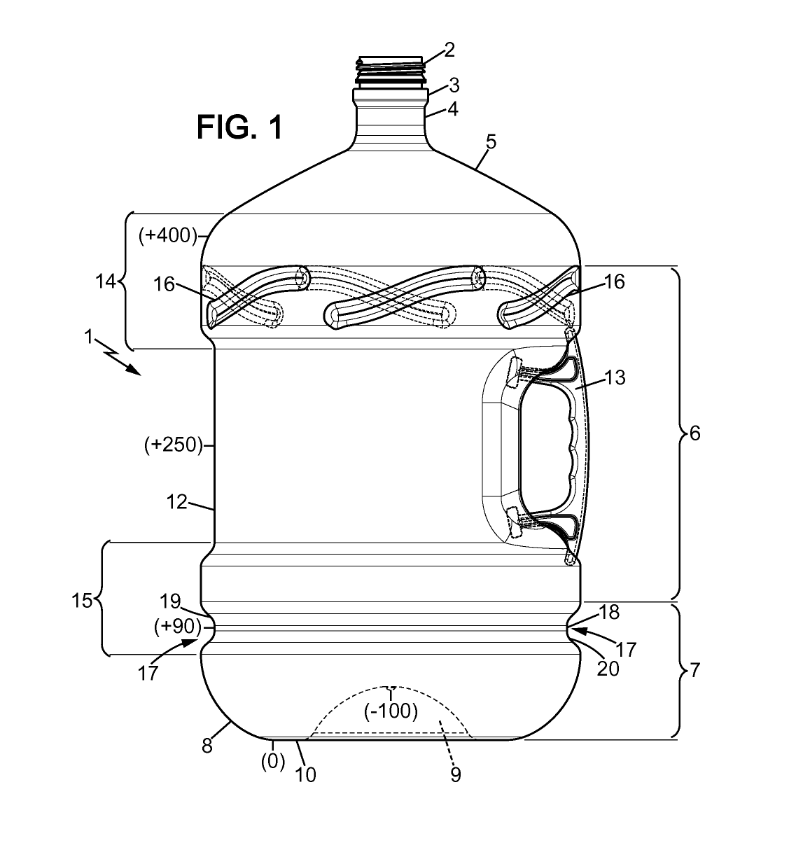

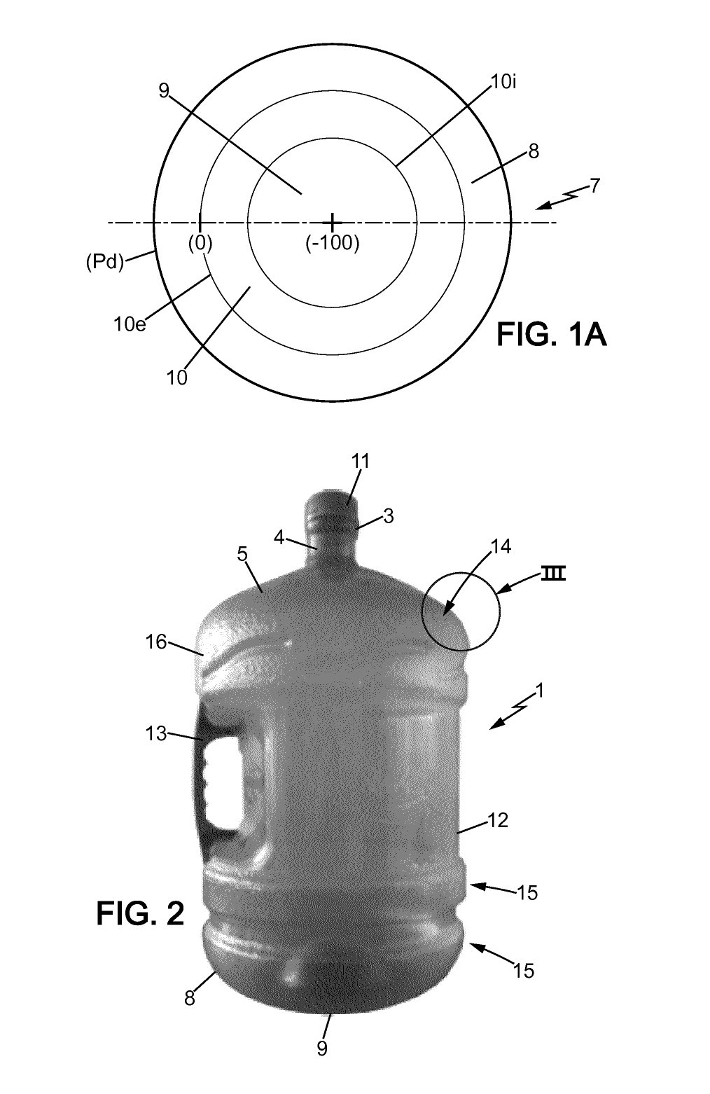

The container shown on FIGS. 1-4 is a biaxial stretched blow molded bottle (1), which has a general cylindrical shape and which is made of PET. This bottle is a large-sized (e.g 20 litres) handled refillable and reusable jug which is intended to contain water for dispenser units for Home and Office Delivery. Each jug (1) is set up-side down on a dispenser and is composed, from the top to the base, of the following parts:
a threaded neck (2)
a skirt (3)
an unthreaded neck (4)
a shoulder (5)
a tubular body portion (6)
and an integral bottom structure (7) including:
   a terminal curved portion (8)
   an internal axially inwardly directed dome (9)
   and an base (10) joining the terminal curved portion (8) to the dome (9).

The neck of the bottle (1) shown on FIG. 1, is closed by a cap (11) screwed on the threaded neck (2).

The tubular body portion (6) has an annular recess (12) wherein a handle (13) is fitted This handle is done in an other step by injection of thermoplastic material, for instance a polyolefin like polypropylene —possibly with a colorant and a foaming agent.

The two annular parts which on both sides of the recess (12) are annular embossed outer areas (14,15) which are intended to limit scuffing in these areas which are contact areas between the bottles (1) as they are stored side-by-side, on filling line during convoying or in transport. The upper annular embossed anti-scuffing area has the reference (14) and the lower one the reference (15).

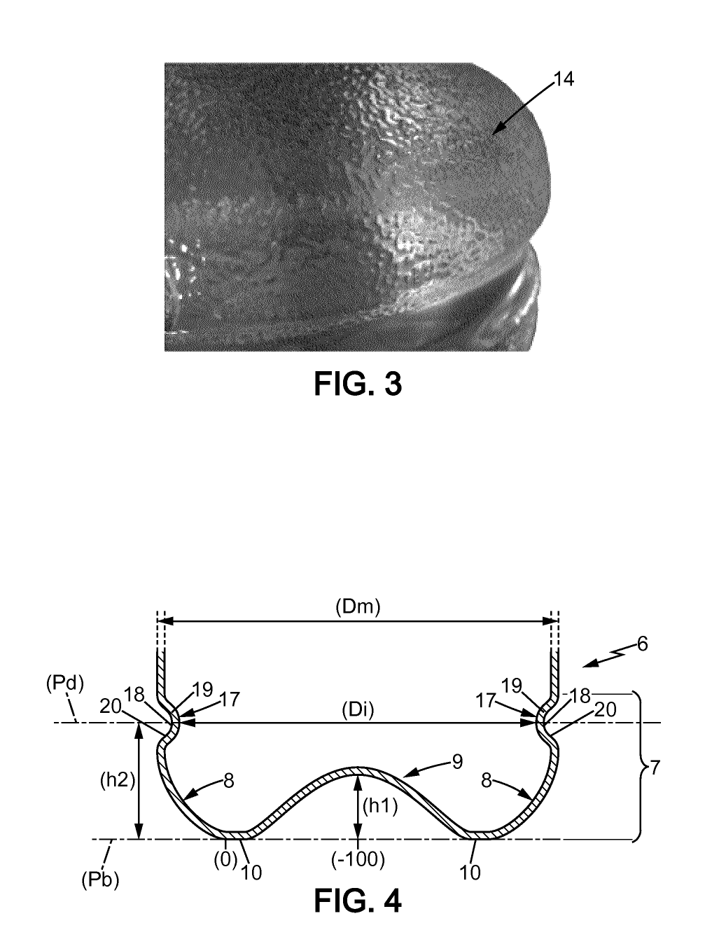

FIG. 3 shows a detail of the two annular embossed anti-scuffing areas. The surface of these areas (14,15) show some holes and some bumps, which are formed by the etching of internal wall of the mold during the molding process. The depth of the holes of the embossed outer areas (14,15), on the bottle (1), is e.g. comprised between 0.4 and 0.9 mm.

These outer annular embossed by etching areas (14,15), can comprise, as other parts of the bottle (1), some decorative patterns such as the grooves or flutes (16).

The integral bottom structure (7) of the bottle according to the invention has a special feature which is the annular spline (17) shown in details on the FIG. 4.

Said annular spline (17) is composed of a flat bottom (18) and two walls: an upper wall 19 and a lower wall 20.

The depth of the spline (17) is determined by the difference between the maximum external diameter (Dm) of the tubular body portion (6) and the minimum internal diameter (Di) of the spline (17). (Dm)& (Di) are represented on FIG. 4.

For instance, (Dm)−(Di)=15 mm.

The terminal curved portion (8) extends from (Pd) to the annular base (10) which is substantially flat and on which the bottle rests when it stands up. This annular base (10) is included in the bottom plane drawn on FIG. 4 and is delimited by two concentric seat circles: an external one (10e) and an internal one (10i).

The dome (9) fills the hollow space in the middle of the annular base (10). Said dome is hemispherical in this example, but the invention is not limited to this shape.

According to the invention, the integral bottom structure (7) is notably characterized by the heights (h1) & (h2).
(h1) is the height between (Pb) and the apex of the dome.
(h2) is the height between (Pb) and the spline diametral median plane (Pd) parallel to (Pb).
   In this particular embodiment:
(h1)=39 mm
(h2)=63.75 mm
[(h1)/(Dm)]*100 is equal to 14%
(h1)<(h2)≦3.5(h1).

These features have been specially selected according to the invention in order that, during the stretch blow mold manufacture process, the blowing of a softened preform forms a bubble of plastic which comes into contact with the bottom of the cavity of the spline (17) and with the cavity of the dome (9) so as to stretch the plastic all around the bottom of the mold in order to obtain finally the terminal curved portion (8) of the bottle.

The so obtained terminal curved portion (8) biaxially stretched, is transformed from an amorphous state to a solid and resistant crystalline state. Such a terminal curved portion (8) brings some highly increased resistance to shocks, notably to vertical drops, to compensate the lower mechanical resistance of the dome (9), which is usually amorphous.

There are others outstanding features of the invention, which are linked to the wall thickness of the bottle (1) and notably of the terminal curved portion (8).

In order to assess the wall thickness, a generatrix of the bottle (1) is drawn as shown on the FIGS. 1, 1A & 4.

The generatrix is graduated from (0) to (−100) and from (0) to (+400).

The origin (0) is placed on the external circle (10e) which delimits the annular flat base (10) from the terminal curved portion (8). Said origin (0) is the lower point of the terminal curved portion (8) and is also on the bottom plane (Pb).

The abscissa (−100) is the apex of the dome (9).

The abscissa (+90) appears on FIG. 4 and is on the spline diametral median plane (Pd) which is in the middle of the flat bottom (18) of the spline (17) and which corresponds to (Di) on the

FIG. 4.

The abscissa (+250) is in the middle of the recess (12).

The abscissa (+400) to the point which is on the radius of the curvature between the shoulder (5) and the tubular body portion (6).

And,

(t0); t(−100); (t+90); t(+250) & t(+400) are respectively, for instance, the wall thicknesses at the abscissas (0); (−100); (+90); (+250) & (+400).

According to a preferred feature of the invention, in the present embodiment:
the wall thickness (t) between the abscissas (0) and (+90) is comprised between 0.7*(t0) and 0.9*(t0);
the wall thickness (t) between the abscissas (0) and (−100) is comprised between 1.5*(t0) and 4.0*(t0).

More generally, the wall thickness of the jug according to this present embodiment, is given in mm on the graph of FIG. 6, from the abscissa (−100) to (+400). It appears that the wall thickness (t) is lower than 1 mm from 0 to +90 [terminal curved portion (8)], as well as from abscissa (+90) to abscissa (+400) [coupling curvature between the tubular body portion (6) and the shoulder (5)].

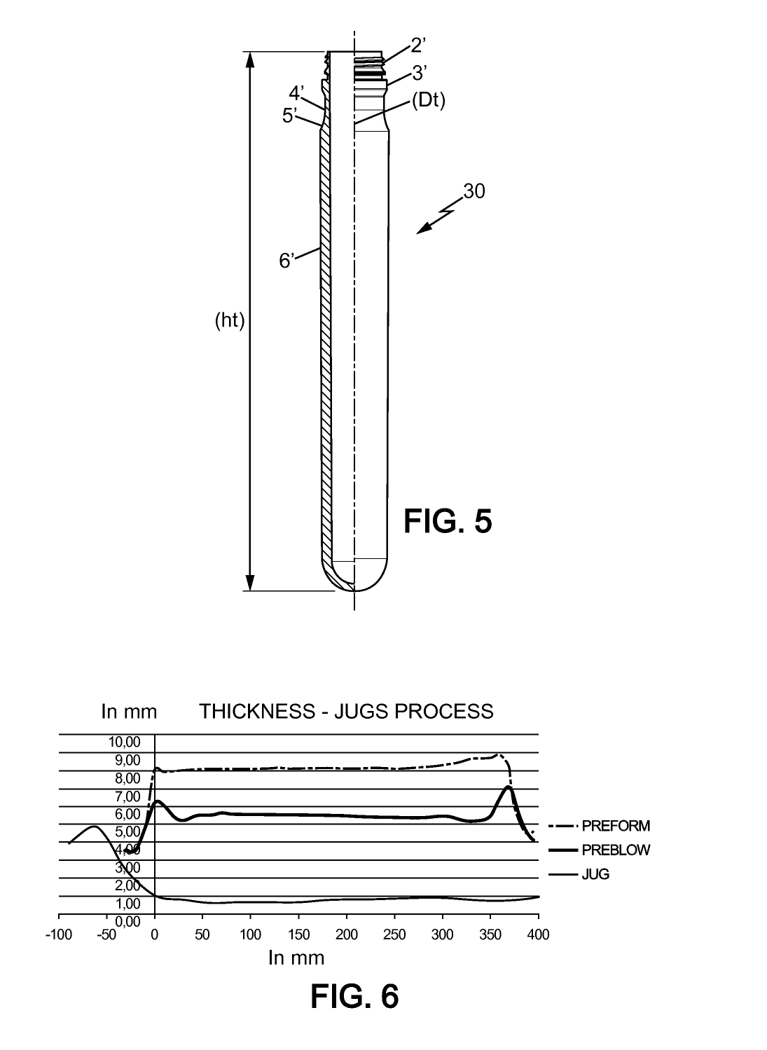

FIG. 5 represents a moulded plastic preform (30) for the blow molding manufacture of the bottle or the jug (1) as above described.

Said preform (30) includes from the top to the bottom:
a threaded neck (2′);
a skirt (3′);
an unthreaded neck (4′);
a shoulder (5′);
and a closed tubular body portion (6′) the external diameter of which is (dt)=55 mm and/or the height of which is (ht)=450 mm.

The wall thicknesses of the preform (30) determined along a graduated generatrix similar to the one used for the bottle/jug (1), are given on the graph of FIG. 6. The wall thicknesses of the preform (30) are comprised between around 5 mm from the abscissa (−25) to around 8.00 to 9.00 mm from the origin (0) and the abscissa (+400).

As far as the blow moulding manufacturing method of the bottle/jug (1) is concerned, the following steps are contemplated:
A. moulding of the plastic preform (30);
B. Heat conditioning and preblowing of the preform (30) obtained in step A so as to increase (dt) of 45% and (ht) of 0%;
C. inserting a handle (13) in the blow molding mold for overmolding (30);
D. stretch blow moulding of the preform (30);
E. taking out of the bottle/jug (1).

The mold for the stretch blow molding manufacture of the bottle/jug (1) as above defined, presents the following features:
the cavity of said mold being designed according the bottle/jug (1),
said mold comprising venting holes facing the embossed outer area(s) and regularly disposed around the circular cavities of the embossed outer area(s);
said venting holes having a diameter of 5 mm;
the surface of these venting holes corresponding to a percentage of the surface of the embossed area(s) comprised between 0.45 and 0.7.

### Example

20 litres jugs are manufactured by injection and blowing with a shell mold in aluminium (3 parts). Vent holes of 5 mm have been done in the etching area and 0.3 mm in the engraving area. The thermoplastic raw material is a Pet resin INVISTA T94.

The parameters of the process are usual ones. Heat conditioning and preblow step B are implemented.

The dimensions of the preform, the preblow and the jugs are as follows:

| | Preform | Preblow | Jug |
|---|---|---|---|
| | (injection | (heat conditioning | (blowing |
| | step A) | step B) | step C) |
| Diameter (dt) | 55 | 75 | 275.5 |
| Height (ht) | 450 | 450 | 496 |

A handle is injected on a 4 cavities mold on a standard injection press. The raw material of the handle is Polypropylene
The jugs have a good appearance of after blowing
The thickness distribution of the preforms, the preblows, and the jugs is given on FIG. 6.
The resistance to shocks of the jugs is assessed with a drop test.

### Protocol Hod Bottles Drop Test

The objective of this drop test is to measure the resistance of a jug filled and capped at a cumulative and vertical drop. The bottle is dropped from 7 feets (2.1 meters): distance between the bottom of the bottle and the floor in concrete.

For this purpose, the bottle is filled with water at 15° C.±2° C. and a level of water at 100 mm±5 mm and is capped. The bottle is conditioning during 24 hours at room temperature. Then, the bottle is dropped. The fall of the bottle is free, but the body of the bottle is guided with a tube. The tube has a diameter bigger than the maximal diameter of the bottle.

As it is a cumulative drop, the drops on the same bottle are done until its breakage. The number of drops included the drop when the bottle breaks.

### Results:

| Number of drops | Drop test @2.1 m |
|---|---|
| Jugs PET standard on the ARGENTINIAN market | 3 |
| Jugs PET according to the present invention | 20 |
| Jugs in Polycarbonate on the MEXICAN market | 8 |

1. A moulded plastic bottle for beverages, said bottle being of the type including from the top to the base:
a neck
a shoulder
a tubular body portion
and an integral bottom structure including:
a terminal curved portion
an internal axially inwardly directed dome
and an base joining the terminal curved portion to the dome;
wherein:
i. a continuous or discontinous the wall thickness (t) between the abscissas spline is designed between the tubular body portion and the terminal curved portion;
ii. the base comprises a part, preferably a flat part, which is included in the base plane (Pb) onto the bottle rests when it stands up;
iii. the height (h1) between (Pb) and the apex of the dome,
the height (h2) between (Pb) and the spline diametral median plane (Pd) which is in the middle of the spline mentioned above in (i) and which is parallel to (Pb), and,
the maximum external diameter (Dm) of the tubular body portion, being so that at least one of the following design features is fulfilled:
a. [(h1)/(Dm)]×100 is, [in % and in an increasing order of preference]:
is greater than 11, greater than or equal to 11.5; 12.0; 12.5; 13.0; 13.5;
is comprised between 14.0 and 20.0; 14.0 and 18; 14.0 and 16.0;
b. In an increasing order of preference:
(h1)<(h2)≦1.5(h1)
(h1)<(h2)≦2.0(h1)
(h1)<(h2)≦2.5(h1)
(h1)<(h2)≦3.0(h1)
(h1)<(h2)≦3.5(h1).

2. A moulded plastic bottle according to claim 1 wherein (feature c):
the wall thickness (t0) at the origin of at least one of the generatrix of the bottle, said origin being the lower point of the terminal curved portion,
the wall thickness (t+90) at the abscissa (+90) which is the abscissa at the intersection between the spline diametral median plane (Pd) and the generatrix of the bottle,
and the wall thickness (t−100) at the abscissa (−100) which is the abscissa at the apex of the dome; being so that:
the wall thickness (t) between the abscissas (t0) and (t+90) is comprised 0.3*(t0) and 1.00*(t90), preferably between 0.5*(t0) and 0.9(t0), and, more preferably between 0.7*(t0) and 0.9*(t0);
the wall thickness (t) between the abscissas (t0) and (t−100) is comprised 1.0*(t0) and 6.0*(t0), preferably between 1.2*(t0) and 5.0*(t0), and, more preferably between 1.5*(t0) and 4.0*(t0).

3. A moulded plastic bottle according to claim 1 wherein the plastic is chosen preferably among the polymers which exhibit strain hardening when they are elongated, and, more preferably among the polyesters, particularly the aromatic polyesters, more particularly chosen in the group comprising, and even more particularly consisting in: PolyEthylene Terephtalate (PET) and/or PolyEthyleneNaphtalate (PEN) or PolyEthylene Furanoate (PEF).

4. A moulded plastic bottle (1) according to claim 1 wherein the base is substantially flat.

5. A moulded plastic bottle according to claim 1 wherein the minimum internal diameter (Di) of the spline is so that [(h1)/(Di)]*100 is, in % and in an increasing order of preference:
greater or equal to 10.0; 11.0; 12.0; 13.0; 13.5;
and comprised between 14.0 and 20.0; 15.0 and 18.0; 15.0 and 17.0.

6. A moulded plastic bottle according to at claim 1 wherein the bottom of the spline is substantially flat.

7. A moulded plastic bottle according to claim 1 wherein the terminal curved portion of the integral bottom structure has a high crystalline rate.

8. A moulded plastic bottle according to claim 1 wherein the tubular body portion comprises at least one recess, wherein a handle is preferably fitted.

9. A moulded plastic bottle according to claim 1 comprising at least one embossed outer area to limit scuffing.

10. A moulded plastic bottle according to claim 8 comprising two upper and lower embossed outer areas, on both sides of the recess.

11. A moulded plastic bottle according to claim 8, wherein the depth of the holes of the embossed outer areas, is [in mm and in an increasing order of preference]: greater than or equal to 0.3; 0.4; 0.5; comprised between 0.6 and 0.9.

12. A moulded plastic preform for the manufacture by blow molding of the bottle according to claim 1.

13. A method for the manufacture by blow moulding of the bottle according to claim 1, said method comprising the steps of:
A. moulding a plastic preform according to claim 12, said preform being of the type including from the top to the base:
a neck;
a shoulder;
and a closed tubular body portion, the external diameter of which is (dt) and/or the height of which is (ht);
B. possibly heat conditioning and preblowing the preform obtained in step A so as to increase:
(dt) [in % and in an increasing order of preference]: of at least, 5; 10; 15; 20; between 20 and 40;
and/or (ht) [in % and in an increasing order of preference]: of at least, 0.1; 0.5; 1.0; 5; 10; between 10 and 20;
C. possibly inserting a handle in the preform obtained in step A and possibly step B;
D. stretch blow moulding of the preform of step A and possibly step B and/or step C, in a mould the cavity of which being the bottle; said stretch blow molding comprising the blowing of the softened preform to get a bubble of plastic which comes into contact with the bottom of the cavity of the spline and with the cavity of the dome so as to stretch the plastic all around the bottom of the mold in order to obtain finally the terminal curved portion of the bottle;
E. taking out of the bottles.

14. A mold for the manufacture by blow molding of the bottle according to claim 8, wherein:
the cavity of said mold being designed according the bottle,
said mold comprising venting holes facing the embossed outer area(s) and regularly disposed around the circular cavities of the embossed outer area(s);
said venting holes having a diameter [in mm and in an increasing order of preference]: greater than or equal to 1; 2; 3; 4; comprised between 4 and 6;
the surface of these venting holes preferably corresponding to a percentage of the surface of the embossed area(s) [in an increasing order of preference]: greater than or equal to 0.05; 0.2; 0.3; 0.4; comprised between 0.45 and 0.7.
